(19) United States
(12) Patent Application Publication
(10) Pub. No.: US 2012/0054401 A1
(43) Pub. Date: Mar. 1, 2012

(54) Method And System For A Mobile Device Docking Station

(76) Inventor: Jeff Cheng, Chicago, IL (US)

(21) Appl. No.: 13/014,822

(22) Filed: Jan. 27, 2011

Related U.S. Application Data
(60) Provisional application No. 61/376,734, filed on Aug. 25, 2010.

(51) Int. Cl. G06F 13/00

(52) U.S. Cl. 710/304

(57) ABSTRACT

Various aspects of a method and system for a mobile device docking station are provided. A docking device may comprise a screen, controls, and a receptacle for holding a mobile device. A mobile device may generate and display information for on its screen while concurrently generating and outputting information to the docking device for display on the screen of the docking device. A user may be enabled to interact, via the controls of the docking device and/or the controls of the mobile device, with the information displayed on the screen of the mobile device and/or with the information displayed on the screen of the docking device. The information displayed on the screen of the docking device may comprise a window of a first application. The information displayed on the screen of the mobile device may comprise a window of a second application.

### CLAIM OF PRIORITY

This patent application makes reference to, claims priority to and claims benefit from U.S. Provisional Patent Application Ser. No. 61/376,734 filed on Aug. 25, 2010.

The above stated application is hereby incorporated herein by reference in its entirety.

### FIELD OF THE INVENTION

Certain embodiments of the invention relate to mobile electronic devices. More specifically, certain embodiments of the invention relate to a method and system for a mobile device docking station.

### BACKGROUND OF THE INVENTION

Mobile communications have changed the way people communicate and mobile electronic devices have been transformed from a luxury item to an essential part of every day life. Currently, most mobile devices are equipped with a user interface that allows users to access the services provided via the Internet. For example, some mobile devices may have browsers, and software and/or hardware buttons may be provided to enable navigation and/or control of the user interface. Some mobile electronic devices such as smart phones are equipped with touch screen capability that allows users to navigate or control the user interface via touching with one hand while the device is held in another hand. Even though functionality and quality of use of mobile electronic devices have improved drastically in the relatively short amount of time they have been around, users are continually demanding improved functionality and better user experience.

Further limitations and disadvantages of conventional and traditional approaches will become apparent to one of skill in the, art, through comparison of such systems with some aspects of the present invention as set forth in the remainder of the present application with reference to the drawings.

### BRIEF SUMMARY OF THE INVENTION

A method and/or system are provided for a mobile device docking station, substantially as illustrated by and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF THE DRAWINGS

FIGS. 1A and 1B illustrate an example of a mobile device docking system (MDDS), in accordance with an embodiment of the invention.

FIGS. 2A and 2B illustrate an example of a mobile device, in accordance with an embodiment of the invention.

FIG. 3A is a side view illustrating docking a mobile device to a mobile device docking station (MDDS), in accordance with an embodiment of the invention.

FIG. 3B is a top view illustrating docking a mobile device to a mobile device docking station (MDDS), in accordance with an embodiment of the invention.

FIGS. 4A and 4B illustrate an example of a mobile device docking station (MDDS) having a form factor of a notebook computer, in accordance with an embodiment of the invention.

FIGS. 5A and 5B illustrate an example of a mobile device docking station (MDDS) having a form factor of a computer configurable into notebook and tablet configurations, in accordance with an embodiment of the invention.

FIGS. 6A and 6B illustrate an example of a mobile device docking station (MDDS) having a form factor of a tablet device, in accordance with an embodiment of the invention.

FIGS. 7A and 7B illustrate another example of a mobile device docking station (MDDS) having a form factor of a tablet device, in accordance with an embodiment of the invention.

FIGS. 8A and 8B illustrate another example of a mobile device docking station (MDDS) having a form factor of a tablet device, in accordance with an embodiment of the invention.

FIGS. 9A and 9B illustrate an example of a mobile device docking station (MDDS) for which a mobile device is docked with the MDDS by sliding the mobile device in via an opening in the edge of the MDDS, in accordance with an embodiment of the invention.

FIGS. 10A-10D illustrate multiple display/view options for a mobile device docked with a mobile device docking station (MDDS), in accordance with an embodiment of the invention.

### DETAILED DESCRIPTION OF THE INVENTION

Various aspects of a method and/or system for a mobile device docking station are provided herein. As utilized herein the terms “circuits” and “circuitry” are utilized to refer to physical electronic components (i.e. hardware) and any software and/or firmware (“code”) which may configure the hardware, be executed by the hardware, and or otherwise be associated with the hardware. As utilized herein, “and/or” means any one or more of the items in the list that is joined by “and/or”. For example, “x and/or y” means any element of the three-element set {(x), (y), (x, y)}. Similarly, “x, y, and/or z” means any element of the seven-element set {(x), (y), (z), (x, y), (x, z), (y, z), (x, y, z)}.

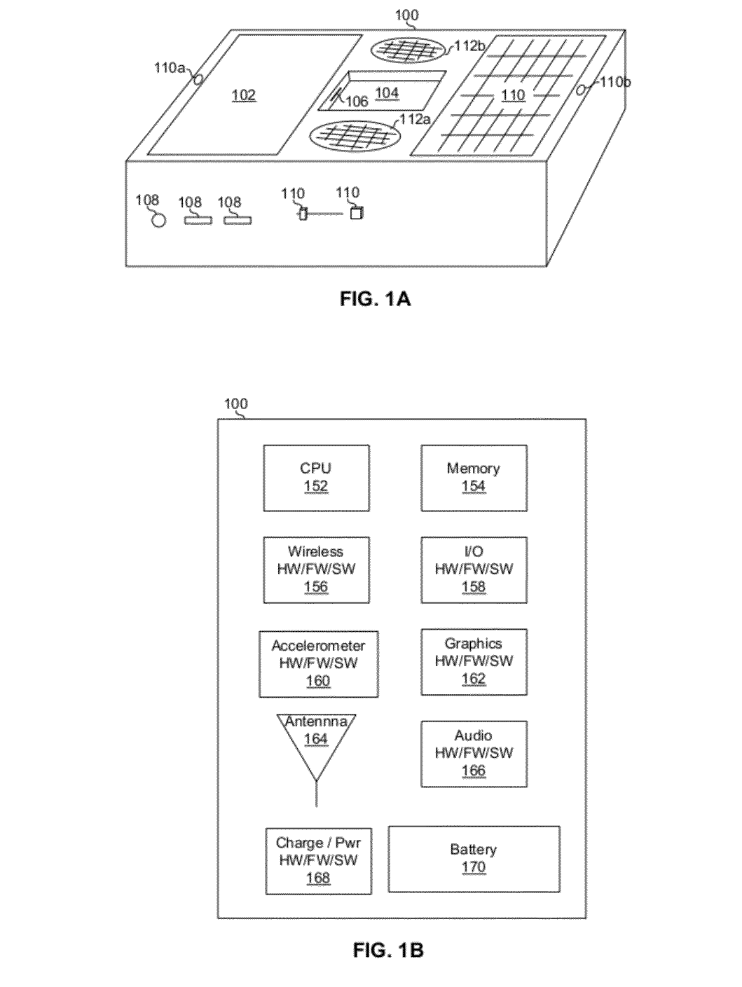

FIGS. 1A and 1B illustrate an example of a mobile device docking station (MDDS), in accordance with an embodiment of the invention. Referring to FIG. 1A the exemplary MDDS 100 comprises a screen 102, a receptacle 104, a connector 106, input/output ports 108, input devices and/or controls 110, speakers 112a and 112b, a camera 110a, and a microphone 110b. The components of the MDDS 100 are merely exemplary and not intended to be an exhaustive list of possible components or features of an MDDS. That is, a particular MDDS may have fewer components and/or features than the MDDS 100 or may have more components and/or features than the MDDS 100.

The screen 102 may comprise suitable circuitry operable to convert electrical signals to visual images. The screen 102 may be, for example, a liquid crystal screen (LCD), a light emitting diode screen (LED), an organic light emitting diode screen (OLED), an active matrix organic light emitting diode (AMOLED) display, or other suitable screen. The screen 102 may be a touch screen input device. The screen 102 may be electrically and/or communicatively coupled to the connector 106, one or more of the ports 108, and/or the camera 110a. That is, information displayed on the screen 102 may be input to the MDDS 100 via the connector 106, via one or more of the ports 108, and/or via the camera 110a. In an embodiment of the invention, minimal video processing may be performed in the MDDS 100 such that video signals received via the connector 106 and/or the connectors 108 may be passed-through to the screen 102 essentially as they were received from the video source. In such an embodiment, the MDDS 100 may perform simple operations such as adjusting resolution but may rely on the video source to perform more complex video processing operations (e.g., color enhancement, artifact reduction, decompression, deinterlacing, scaling, etc.)

In another embodiment of the invention, the MDDS 100 may be operable to perform relatively complex video processing operations. Such an embodiment may improve the image quality, particularly in situations where the source of the video has limited resources (e.g., a mobile device may have relatively limited video processing capabilities).

The receptacle 104 may be a recessed area or cavity in which a mobile device may be placed or inserted. In an embodiment of the invention, the receptacle may comprise a means for holding the mobile device in place in the receptacle 104. For example, a mobile device may be held in place in the receptacle by a latch, by friction between the mobile device and the MDDS 100, by a spring-loaded or otherwise elastic or flexible mechanism or material for exerting pressure on the mobile device, and/or by magnetic force, such that the mobile device will remain in the receptacle 104 as the MDDS 100 is rotated along any axis or combination of axes

In an embodiment of the invention, the receptacle 104 may provide heat-sinking and/or cooling for a mobile device docked in the receptacle 104. For example, the receptacle 104 may comprise a metal heatsink for drawing heat away form a docked mobile device. As another example, one or more walls of the receptacle 104 may be slotted such that air may pass under and/or around a docked mobile device.

The connector 106 may be located in the receptacle 104 and may comprise suitable circuitry for electrically coupling to a mobile device placed in the receptacle 104. The electrical and mechanical features of the connector may support any suitable input/output standard or protocol such as, but not limited to, Universal Serial Bus (USB), Micro-USB, Apple Dock connector, High-Definition Multimedia Interface (HDMI), and IEEE 1394. In an embodiment of the invention, the connector 106 may be electrically or manually retractable. In this regard, placing the connector 106 in a retracted position may enable inserting and removing the mobile device from the receptacle 104. Placing the connector 106 in an extended position, while a mobile device is in the receptacle 104, may cause the connector 106 to be inserted into a mating connector on the mobile device.

In addition to a wired connection to the mobile device via the connector 106, the MDDS 100 may be operable to communicate with a mobile device wirelessly. For example, the MDDS 100 may be operable to communicate in accordance with IEEE 802.11, Bluetooth, wireless USB, Infrared, cellular standards, and/or other wireless standards. Exemplary cellular standards comprise Global System for Mobile Communications (GSM), Code Division Multiple Access (CDMA), Worldwide Interoperability for Microwave Access (WiMax), and Long Term Evolution (LTE).

The wireless functionality of the MDDS 100 may enable it to operate as a wireless router, wireless modem, base-station, and/or femtocell. In this manner, the MDDS 100 may provide wireless connectivity to devices connected to it via the connector 106 and/or a connector 108

In an embodiment of the invention, the MDDS 100 may be operable to communicate with a mobile device via the connector 106 while concurrently communicating wirelessly with the same mobile device and/or other mobile devices. For example, input (e.g., user commands such as button and/or key presses on the controls 110, and/or gestures on the touch screen 102) may be communicated to a docked mobile device via Bluetooth while the mobile device outputs multimedia content to the MDDS 100 via the connector 106.

In an embodiment of the invention, the MDDS 100 may be operable to adjust wireless communications settings, such as amplifier gain and antenna directionality, based on whether the device with which the MDDS 100 is communicating is docked in the receptacle 104. That is, the distance to a mobile device and the orientation of the mobile device relative to the MDDS 100 may be fixed as a result of being docked in the receptacle 104, and the MDDS 100 may take advantage of this known distance and/or orientation. This may result in improved energy efficiency and longer battery life when the MDDS 100 is wirelessly communicating with a docked device.

The input/output connectors 108 may comprise suitable circuitry that enables communications between the MDDS 100 and other devices such as mobile devices, computers, audio/video equipment, and mass storage devices. Although three ports are shown for illustration, any number of ports may be present on a given MDDS 100. The electrical and mechanical features of the connector 108 may support any suitable input/output standard or protocol such as, but not limited to, Universal Serial Bus (USB), Micro-USB, Apple Dock connector, High-Definition Multimedia Interface (HDMI), IEEE 1394, Ethernet, analog video in (e.g., composite video or s-video), analog video out (e.g., composite video or s-video), analog audio in (e.g., microphone in and/or line-in), and/or analog audio out (e.g., a headphone jack). Information communicated via the connector 108 may comprise, for example, user interface data (e.g., input from a mouse, keyboard, and/or gaming controller), audio data, and/or video data.

Additionally or alternatively, one or more of the input/output connectors 108 may enable supplying power from the MDDS 100 to another device and/or supplying power from another device to the MDDS 100. A battery of the MDDS 100 may be charged via one or more of the ports 108. A battery of a docked mobile device may be charged by power received via a connector 108 and routed to the connector 106. Power received via one of the ports 108 may pass through to one or more other ones of the ports 108. In this manner, a device connected via a first connector 108 may be charged and/or powered via power received via a second connector 108. Energy from a battery of the MDDS 100 may be utilized to charge one or more devices via the connector 106 and/or one or more connectors 108; however, in instances where the battery of the MDDS 100 is low, the MDDS 100 may provide the option of disabling charging from the battery of the MDDS 100. One or more of the ports 108 may comprise an Ethernet port that supports power over Ethernet (PoE).

In an embodiment of the invention, the MDDS 100 may enable a pass-through mode in which power and/or data may be communicated between the connector 106 and one or more of the ports 108. In such a pass-through mode, the MDDS may be invisible to devices communicating via the connector 106 and connectors 108.

In an embodiment of the invention, the mobile device and/or the MDDS 100 may be configurable into a “just charge” mode while docked and may otherwise operate as if it were undocked.

In an embodiment of the invention, the MDDS 100 may be operable to run completely on power from the battery of a docked mobile device and/or on power from a battery of a device connected to a port 108. In such an embodiment, the MDDS 100 may be operable to implement one or more energy saving modes in order to minimize the drain on the other device's battery.

The input devices and/or controls 110 may comprise suitable circuitry operable to convert user input to electrical signals. The input devices may comprise, for example, a camera (explicitly called out as reference designator 110a), a microphone (explicitly called out as reference designator 110b), a touchpad, trackball, keyboard, touch screen, soft keys, hard switches, knobs, and/or buttons. Signals from the input devices 110 may be conveyed to circuitry of the MDDS 100, may be conveyed to a docked mobile device via the connector 106, communicated to other devices via one or more of the connectors 108, communicated to devices wirelessly by the MDDS, wirelessly by a docked mobile device, and/or wirelessly communicated to undocked devices near the MDDS 100. In some instances, signals from the user inputs 110 may be directly conveyed to the connector 106 and/or a connector 108 with little or no processing by circuitry of the MDDS 100. In some instances, the signals from the input devices 110 may be processed in the MDDS 100 (e.g., by a bus adapter and/or transceiver) such that the information conveyed by those signals may be communicated to other devices wirelessly, via the connector 106, and/or via one or more connectors 108.

In an embodiment of the invention, the input devices 110 may comprise a handwriting recognition pad (Digitizer) incorporated into the touch screen 102. A handwriting recognition pad is a user interface device and can communicate user information and command selections to the processor of the mobile device through a wired connection.

In an embodiment of the invention the input devices and/or controls 110 may comprise an accelerometer. The accelerometer may be operable to generate electrical signals that indicate three-dimensional movements of the MDDS.

The camera 110a may comprise suitable circuitry operable to capture still and/or video images and convert those images to electrical signals. In an embodiment of the invention, in instances that a mobile device in communication with the MDDS (wirelessly and/or via the connector 106) is participating in a video conference, video input from the camera 110a may supplement and/or replace video input from a camera of the mobile device.

The microphone 110b may comprise suitable circuitry operable to convert acoustic waves to electrical signals. In an embodiment of the invention, in instances that a mobile device in communication (e.g., wirelessly and/or via the connector 106) with the MDDS 100 is participating in a cellular call, audio input from the microphone 110b may supplement and/or replace audio input from a microphone of the mobile device.

The speakers 112a and 112b may comprise suitable circuitry operable to convert electrical signals to acoustic waves. The speakers 112a and 112b may be electrically and/or communicatively coupled to the connector 106 and/or one or more of the ports 108. The MDDS 100 may, for example, receive analog audio via the connector 106 and/or via one or more of the ports 108. The MDDS 100 may, for example, receive digital audio, which it may then convert to analog signals, via the connector 106, via one or more connectors 108, and/or via a wireless connection (e.g., Bluetooth). Audio information communicated to the speakers 112a and 112b may comprise, for example, voice data from a mobile device participating in a cellular call. Such voice data may be received via the connector 106 and/or via a wireless connection (e.g., Bluetooth) to a mobile device. Audio information communicated to the speakers 112a and 112b may comprise, for example, digital audio read from memory in the MDDS 110, from memory in a docked mobile device via the connector 106, from memory in a device communicating wirelessly with the MDDS, and/or from memory in a device communicating with the MDDS 100 via a port 108.

In an embodiment of the invention, minimal audio processing may be performed in the MDDS 100. For example, the MDDS 100 may receive audio signals which it may amplify and output to the speakers 112a and 112b. Such an embodiment may rely on the audio source to perform any complex audio processing (e.g., equalization).

In another embodiment of the invention, the MDDS may be operable to perform relatively complex audio processing. For example, the MDDS 100 may receive digital audio signals and may be me able to process the digital audio (e.g., perform equalization and/or noise suppression) prior to converting it to analog and outputting it to the speakers 112a and 112b. Such an embodiment may improve the audio quality, particularly in situations where the source of the audio has limited resources (e.g., a mobile device may have relatively limited audio processing capabilities).

In an embodiment of the invention, the docked mobile device may perform the bulk of any data processing and the MDDS 100 may comprise minimal circuitry to enable it to act as an interface for receiving input from a user and providing output (audio and/or video) to a user. That is, in such an embodiment, the MDDS 100 may function as a “thin-client” while the docked mobile device provides most of the processing power.

In another embodiment of the invention, operation of the MDDS 100 and a docked mobile device may be similar to a multi-processor system, a virtual system, and/or a distributed computing system. In a multi-processor system, some processing operations may be allocated to a first processor and some processing operations may be allocated to a second processor. A multi-processor system may, for example, comprise a primary processor and one or more specialized coprocessors (e.g., a video coprocessor, an audio coprocessor, and/or a networking coprocessor) for implementing specific operations (e.g., processing video content, audio content, and/or packet processing). A multi-processor system may, for example, comprise two processors, each of which is a general purpose processor and operations may be allocated among them, for example, on a per-instruction or per-program basis. In such an embodiment, some processing may be performed by the MDDS 100 and some processing may be performed by the docked mobile device. Various protocols may be utilized in determining which system will perform which operations in order to, e.g., optimize speed and/or energy efficiency. A hypervisor may run on the MDDS 100 or on a docked mobile device and one or more virtual machines or OSs may run on each of the MDDS 100 and the docked mobile device.

In an embodiment of the invention, the MDDS 100 may function as a multi-protocol switch or router. In this regard, the MDDS 100 may be an intermediate node along a communication path and the MDDS 100 may convert between various communication protocols. Such operation of the MDDS 100 may enable optimizing communication data rates and energy efficiency. For example, a docked mobile device may desire to communicate with a wireless network. The MDDS 100 may comprise a more efficient antenna for wireless communications. Accordingly, the docked mobile device may output information to the MDDS 100 via the connector 106 and MDDS 100 may perform the necessary processing to generate the appropriate wireless signals for communicating the information to the wireless network. Similarly, the MDDS 100 may receive information from the wireless network, process the received information to make it suitable for conveyance via the connector 106, and communicate the received information to the docked mobile device via the connector 106. In some instances, the MDDS 100 may perform such operations transparently such that the MDDS 100 is invisible to the application on the mobile device that is doing the communicating and/or invisible to the wireless network.

Referring to FIG. 1B, there is shown a functional block diagram of an exemplary MDDS 100. Circuitry of the exemplary MDDS 100 may perform CPU functions 152, memory functions 154, comprise an antenna 164, comprise a battery 170, perform wireless communication functions 156, input/output functions 158, accelerometer functions 160, graphics processing functions 162, audio processing functions 166, and charging and/or power management functions 168. Although FIG. 1B depicts many separate functional blocks, hardware, firmware, and/or software may be shared among multiple functions. Also, a particular MDDS may not implement all of the functions depicted in FIG. 1B or may implement more functions than are depicted in FIG. 1B. In other words, any one or more of the functional blocks depicted in FIG. 1B may be absent in a particular embodiment of the invention. For example, the CPU 152 may execute instructions to run an operating system and/or other programs, provide control signals to various components of the MDDS 100, process data, and/or manage communication of data to and from various components of the MDDS 100. In an embodiment where the MDDS 100 is essentially just an input/output device with minimal processing capabilities (“thin client”), the CPU 152 may be absent and a chipset of a docked mobile device may perform the bulk of the data processing. Conversely, in an embodiment where the MDDS 100 is a high-powered computing device, the CPU 152 may be more powerful than the processor of a docked device and the docked device may offload complex operations to the CPU 152.

The CPU 152 may comprise suitable circuitry for controlling operation of the MDDS 100. For example, the CPU 152 may execute instructions to run an operating system and/or other programs, provide control signals to various components of the MDDS 100, process data, and/or manage communication of data to and from various components of the MDDS 100.

The memory 154 may comprise any suitable memory such as DRAM, SRAM, flash, and/or magnetic storage. In an embodiment of the invention where the MDDS 100 is a thin client, the memory 154 may comprise, for example, just enough memory to buffer one or more video frames to be output to the screen 102 and buffer input data from the controls 110 while it is being communicated to a device that is docked or otherwise in communication with the MDDS 100. In an embodiment of the invention, the memory 154 may function as virtual memory or additional cache for a device that is docked or otherwise in communication with the MDDS 100, and may thus enhance the capacity and/or speed of processing operations performed by such a device. In an embodiment of the invention, the memory 154 may comprise non-volatile mass storage and may be synced with, or mirror, mass storage of a device upon the device being docked or otherwise establishing a connection to the MDDS 100.

The circuitry 156 may be operable to perform signal processing operations in accordance with one or more wireless communications protocols. In an embodiment of the invention, the circuitry 156 may supplement corresponding circuitry in a docked mobile device. For example, the circuitry 156 may be operable to perform additional noise suppression on received wireless signals or may provide additional gain for received or transmitted wireless signals. That is, signals may be received via the antenna 164 and pre-processed by the circuitry 156 before being conveyed to the docked mobile device. The received signal may be pre-processed via circuitry in the MDDS 100 that implements the wireless functions 156. The pre-processed signal may then be conveyed to the docked mobile device, and be further processed in the docked mobile device. In an embodiment of the invention, upon detecting that the MDDS 100 comprises circuitry 156, a docked mobile device may disable its antenna and configure itself to receive wireless signals via the connector 106. This may further reduce the noise present at the input of wireless receiver of the mobile device.

Similarly, outgoing signals from the docked mobile device may be processed by the docked mobile device and then communicated to the MDDS 100 via the connector 106 where they may be further processed by the circuitry 156 of the MDDS 100 that implements the wireless functions 156 prior to being transmitted via the antenna 164. In an embodiment of the invention, the circuitry 156 that performs wireless processing operations may be utilized instead of corresponding functional blocks of a mobile device while the device is docked. For example, while a mobile device is docked, wireless processing in the mobile device may be bypassed and processing for wireless communications may be performed by circuitry of the MDDS 100 that implements the wireless functions 156.

The circuitry 158 may be operable to perform processing of signals corresponding to user inputs such as touch screen gestures on the screen 102, output of the accelerometer, and/or button or key presses on the controls 110. The circuitry 158 may receive the user input signals and format or otherwise condition them for communication to a mobile device via the connector 106, a connector 108, and/or wirelessly via the circuitry 156.

The circuitry 160 may be operable to generate electrical signals that indicate three-dimensional movements of the MDDS. Data from the accelerometer 160 may supplement or be utilized instead of data from an accelerometer of a docked device.

The circuitry 162 may be operable to perform graphics processing functions to format and/or enhance the appearance of video and graphics presented on the screen 102, output via connector 108, and/or output wirelessly via the circuitry 156. In an embodiment of the invention, the circuitry 162 may supplement corresponding circuitry in a mobile device. For example, the circuitry 156 may be operable to perform additional noise suppression, color enhancement, and/or sharpness enhancement on video signals received via the connector 106, received via a connector 108, and/or received wirelessly. In an embodiment of the invention, the circuitry 162 that performs video processing operations may be utilized instead of corresponding functional blocks of a mobile device that is docked or otherwise in communication with the MDDS 100. For example, while a mobile device is docked, video processing in the mobile device may be bypassed. The mobile device may, for example, output a raw, compressed video stream via the connector 106 and the circuitry 162 may perform the decompression, scaling, and other image processing operations.

The circuitry 166 may be operable to perform audio processing functions to format and/or enhance the sound of audio presented via the speakers 112, output via a connector 108, and/or output wirelessly 156. In an embodiment of the invention, the circuitry 166 may supplement corresponding circuitry in a mobile device. For example, the circuitry 166 may be operable to perform additional noise suppression, equalization, and/or provide additional gain for audio signals received via the connector 106, received via a connector 108, and/or received wirelessly. In an embodiment of the invention, the circuitry 166 that performs audio processing operations may be utilized instead of corresponding functional blocks of a mobile device. For example, while a mobile device is docked or otherwise in communication with the MDDS 100, audio processing in the mobile device may be bypassed. The mobile device may, for example, output a raw, compressed audio stream via the connector 106 and the circuitry 166 may perform the decompression, equalization, and other audio processing operations.

In an embodiment of the invention, functional blocks of the MDDS 100 may provide functions not present in a mobile device while the device is docked or otherwise in communication with the MDDS 100. For example, while docked to the MDDS 100, a mobile device (e.g., a personal media player) which does not comprise wireless communication capabilities, or does not support particular wireless standards, may be enabled to communicate wirelessly, or utilize the particular wireless standards, via circuitry of the MDDS 100 that implements the wireless functions 156.

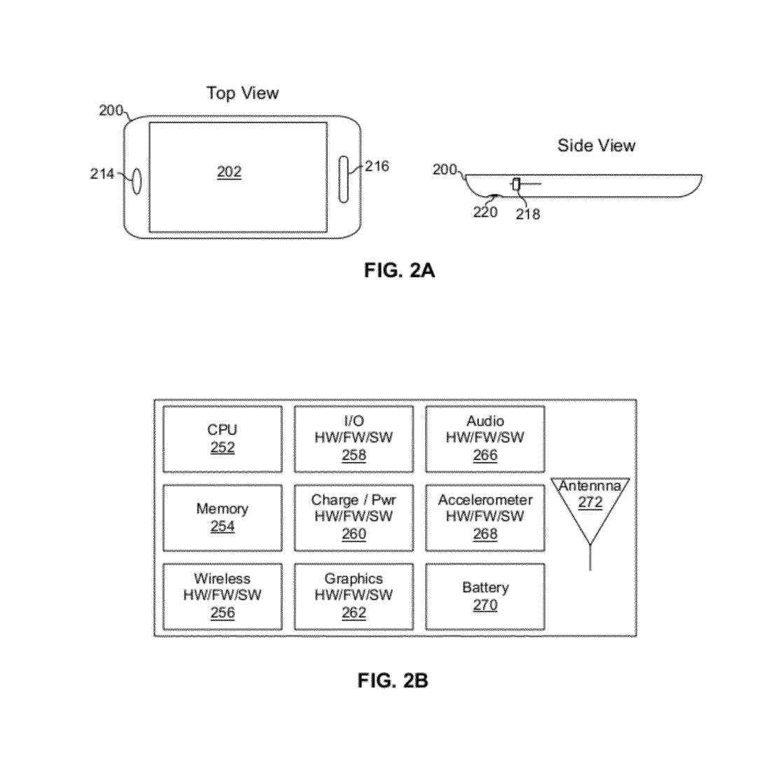

FIGS. 2A and 2B illustrate an example of a mobile device, in accordance with an embodiment of the invention. Referring to FIG. 2A, the mobile device 200 may comprise a screen 202, a microphone 214, a speaker 216, a camera 220, and one or more hardware buttons and/or switches 218. The features are for purpose of illustration only and any particular mobile device may have more or fewer features or components. Exemplary mobile devices comprise smart phones, personal media players, personal gaming systems, ebook readers, or any other wireless and/or handheld electronic device.

Referring to FIG. 2B the mobile device 200 may comprise circuitry for implementing one or more of the same functions as described above with reference to the MDDS 100. As with the MDDS 100, the various functions may be implemented by dedicated and/or shared circuitry. As with FIG. 1B, various functions shown in FIG. 2B may be absent in various mobile devices.

In an embodiment of the invention, the mobile device 200 may be operable to run multiple software operating systems (OSs). For example, the mobile device 200 may be operable to run a first OS while not docked to the MDDS 100 and may run a second OS while docked to the MDDS 100. Each of the OSs may be optimized for its particular use case such that the user experience is enhanced, i.e., a first OS may be optimized for functions performed while docked and a second OS may be optimized for functions performed while undocked. Each of the multiple OSs may be enabled to utilize the same data stored on the mobile device 200, such as movies, emails, music, games, etc., and/or may be enabled to access different data on the mobile device 200. In such an embodiment, the mobile device 200 may be operable to detect that it is docked, and/or the MDDS 100 may be operable to notify the mobile device 200 that it is docked, and transition between the OSs upon docking and undocking. For example, upon docking the mobile device 200, the MDDS 100 and the mobile device 200 may exchange one or more signals as part of a hand-shaking or initialization process. The signals may, for example, indicate the features (e.g., make, model, hardware configuration, and/or software configuration) of the mobile device 200 to the MDDS 100 and the features (e.g., make, model, hardware configuration, and/or software configuration) of the MDDS 100 to the mobile device 200.

In an embodiment of the invention, the mobile device 200 may run the same OS whether it is docked or undocked but may run a first set of applications or services while docked and may run a second set of applications or services while not docked. In an embodiment of the invention, the set of applications run while the mobile device 200 is docked may depend on the features of the MDDS 100.

In an embodiment of the invention, one or more applications on the mobile device 200 may manage operation of the MDDS 100 and/or the mobile device 200, and/or manage interactions between the MDDS 100 and the mobile device 200 while the mobile device 200 is docked. In such an embodiment, these applications may automatically startup upon docking and shutdown upon undocking.

In an embodiment of the invention, one or more applications on the MDDS 100 may manage operation of the MDDS 100 and/or the mobile device 200, and/or manage interactions between the MDDS 100 and the mobile device 200 while the mobile device 200 is docked. In such an embodiment, these applications may automatically startup upon docking and shutdown upon undocking.

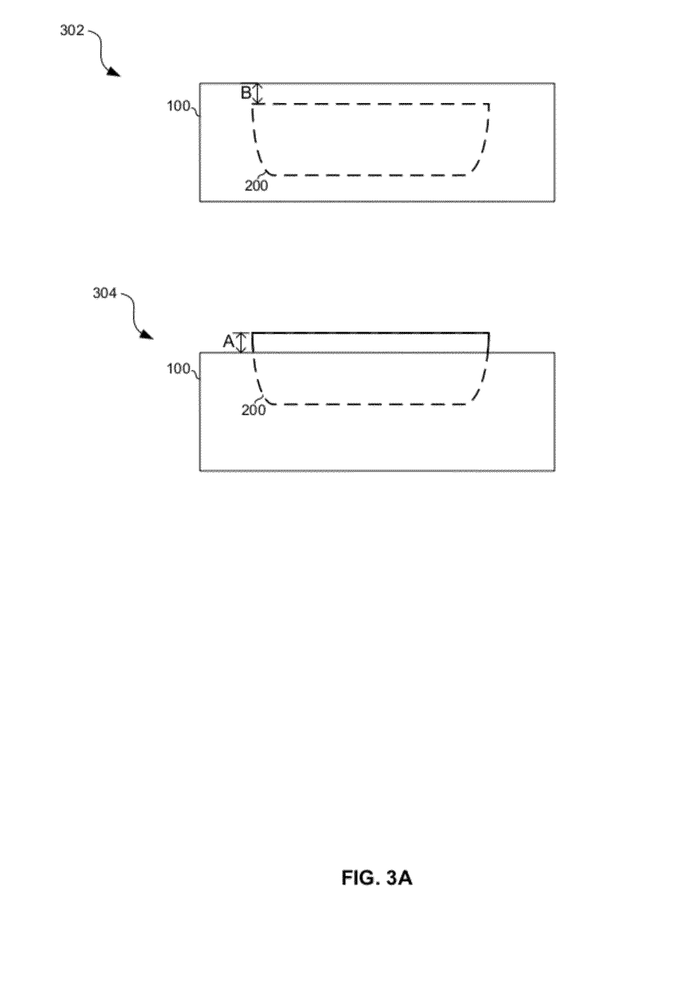

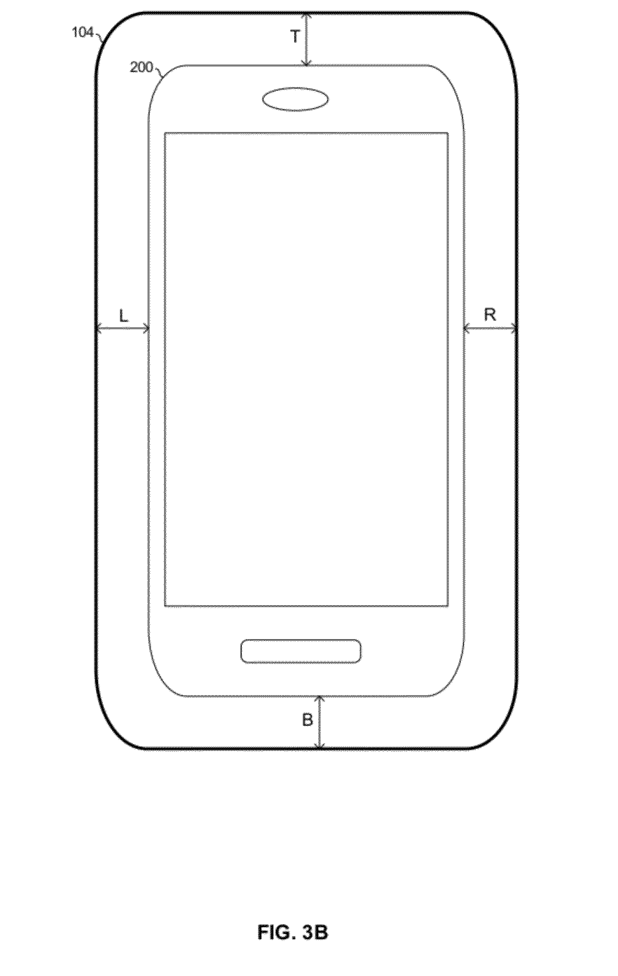

FIG. 3A is a side view illustrating docking a mobile device to a mobile device docking station (MDDS), in accordance with an embodiment of the invention. FIG. 3A, illustrates docking the mobile device 200 to MDDS 100 such that a surface (e.g., the screen 202 or, generically, a “top” surface) of the mobile device 200 is substantially level or flush with a surface (e.g., the screen 102, a surface of the area in which the controls 110 are located, or generically a “top” surface) of the MDDS 100. The surfaces may be substantially flush when the surface of the mobile device 200 is no more than a distance ‘A’ above the surface of the MDDS 100 and no more than ‘B’ below the surface of the MDDS 100. Accordingly, scenario 302 illustrates the surface of the mobile device 200 at the maximum acceptable distance below the surface of the MDDS 100 (i.e. if the receptacle 104 were any deeper, the distance would be too large) and scenario 304 illustrates the surface of the mobile device 200 at the maximum acceptable distance above the surface of the MDDS 100 (i.e. if the receptacle 104 were any shallower the distance would be too large). The values of ‘A’ and ‘B’ may be determined from empirical data as to what users prefer and find comfortable.

In an embodiment of the invention, one or more inserts may be available to adjust the depth of the receptacle 104 to accept various mobile devices.

Although, docking such that the top surfaces are substantially flush is shown, the invention is not so limited. For example, in another embodiment of the invention, the mobile device 200 may dock such that a bottom surface of the mobile device 200 is substantially flush with a bottom surface of the MDDS 100.

FIG. 3B is a top view illustrating docking a mobile device to a mobile device docking station (MDDS), in accordance with an embodiment of the invention. Referring to FIG. 3B, there is shown distances ‘L,’ ‘R,’ ‘T,’ and ‘B’ between the edge of the mobile device 200 and the wall of the receptacle 104. The maximum values of ‘L,’ ‘R,’ ‘T,’ and ‘B’ that still result in acceptable user experience may be determined from testing/empirical data. These four distances are for illustrative purposes only. A variety of shapes and/or sizes for both the mobile device 200 and the receptacle 104 can be used. The mobile device 200 and the receptacle 104 need not mate and/or align on all edges. There are numerous alternative designs that can achieve the intended goal. The aesthetic design of the mobile device 200 does not dictate the aesthetic design of the receptacle 104, and vice versa.

In some instances the receptacle 104 may be sized to accommodate various mobile devices and inserts may be utilized to adapt the receptacle to the shape and/or size of a particular mobile device such that there are not large gaps between the mobile device and the MDDS 100 while the device is docked.

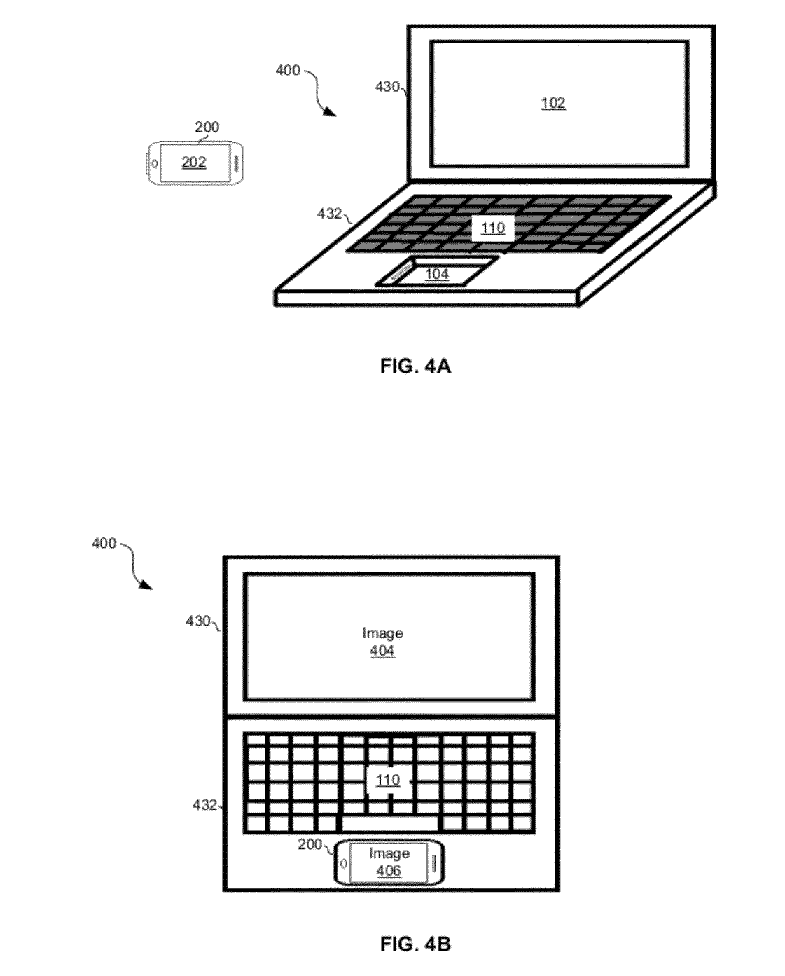

FIGS. 4A and 4B illustrate an example of a mobile device docking station (MDDS) having a form factor of a notebook computer, in accordance with an embodiment of the invention. The MDDS 400 may be substantially similar to the MDDS 100 described above. A hinge between the top portion 430 and the bottom portion 432 may enable the MDDS 400 to close such that the screen 102 faces and rests on, or just above, the keyboard 110. FIG. 4A depicts the mobile device 200 undocked and FIG. 4B depicts the mobile device 200 docked to the MDDS 400. While the device 200 is docked to the MDDS 400, a user may provide input to the device 200 and/or the MDDS 400 via the touch screen 202 of the device 200, via the controls 110 of the MDDS 400, and/or via the touch screen 102 of the MDDS 400.

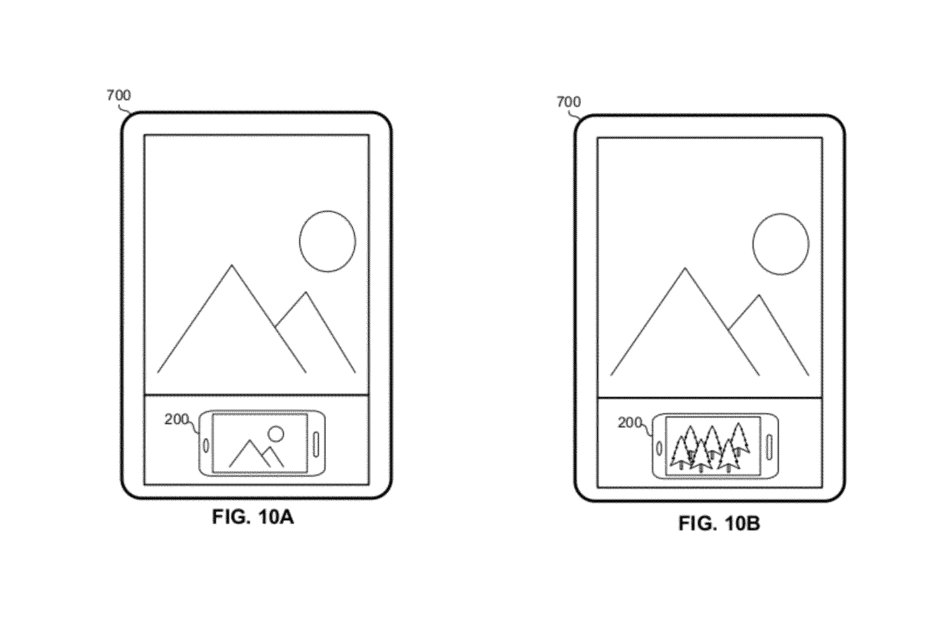

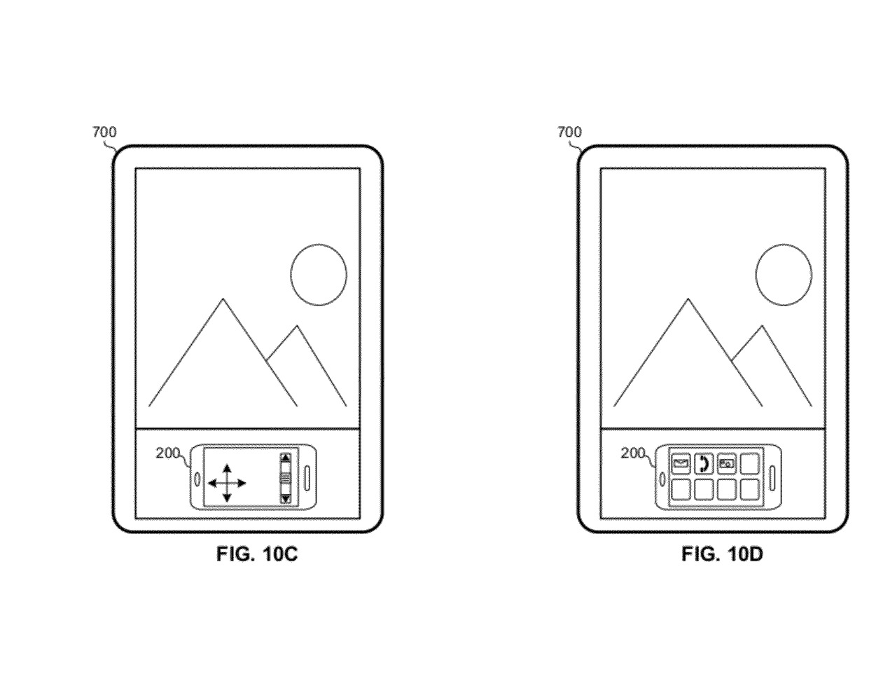

In FIG. 4B, the MDDS 400 may display an image 404 and the docked mobile device 200 may display an image 406. There may be a variety of display/view options for these two images as discussed below with respect to FIGS. 10A-10D.

In an embodiment of the invention, the docked mobile device 200 may function as the touchpad would on a conventional notebook computer.

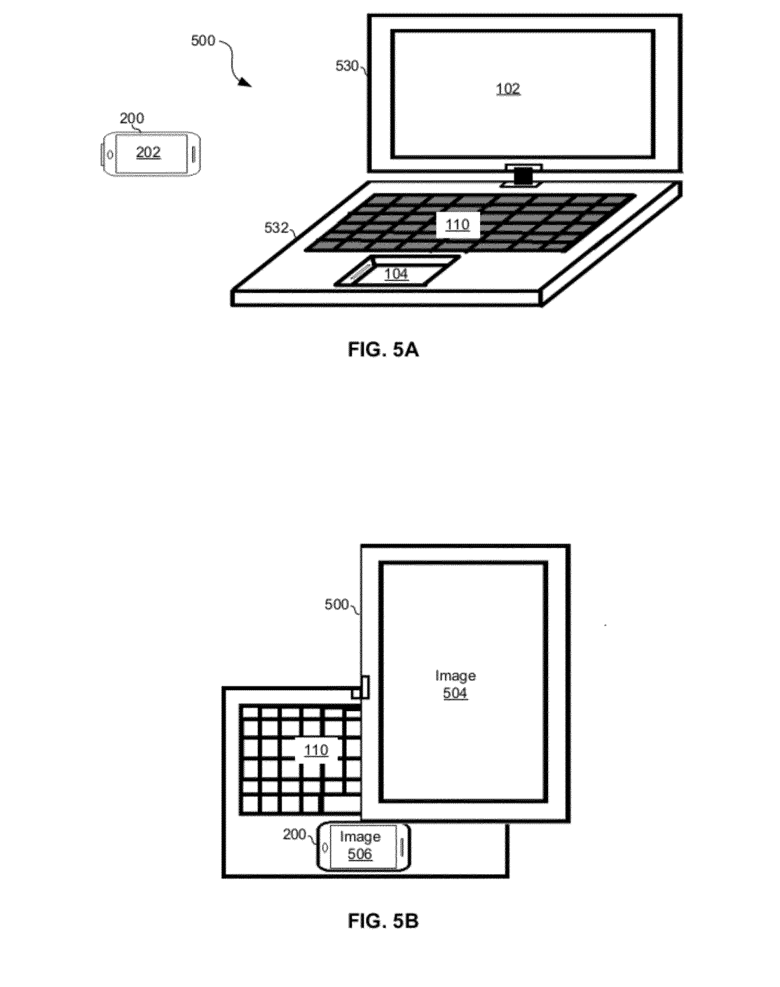

FIGS. 5A and 5B illustrate an example of a mobile device docking station (MDDS) having a form factor of a computer configurable into notebook and tablet configurations, in accordance with an embodiment of the invention. A hinge/swivel between the top portion 530 and the bottom portion 532 may enable the MDDS 500 to open and close like the MDDS 400 of FIGS. 4A and 4B (notebook configuration), and may enable the MDDS 500 to close such that the back of the screen 102 rests on, or just above the keyboard 110, and the screen 102 faces away from the keyboard 110 (tablet configuration). FIG. 5A depicts the mobile device 200 undocked and FIG. 5B depicts the mobile device 200 docked to the MDDS 500. While the device 200 is docked to the MDDS 500, a user may provide input to the device 200 and/or the MDDS 500 via the touch screen 202 of the device 200, via the controls 110 of the MDDS 500, and/or via the touch screen 102 of the MDDS 500.

In FIG. 5B, the MDDS 500 may display an image 504 and the docked mobile device 200 may display an image 506. There may be a variety of display/view options for these two images as discussed below with respect to FIGS. 10A-10D.

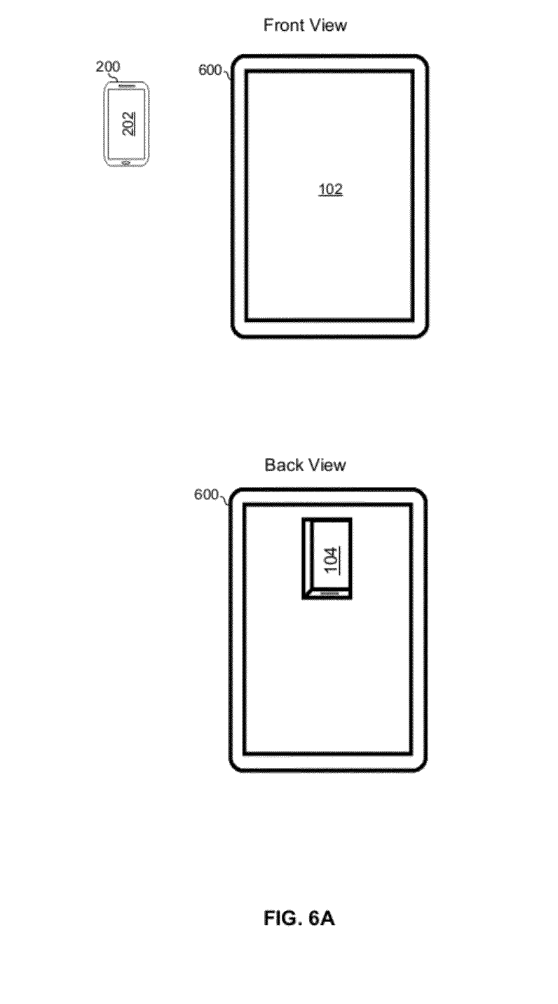

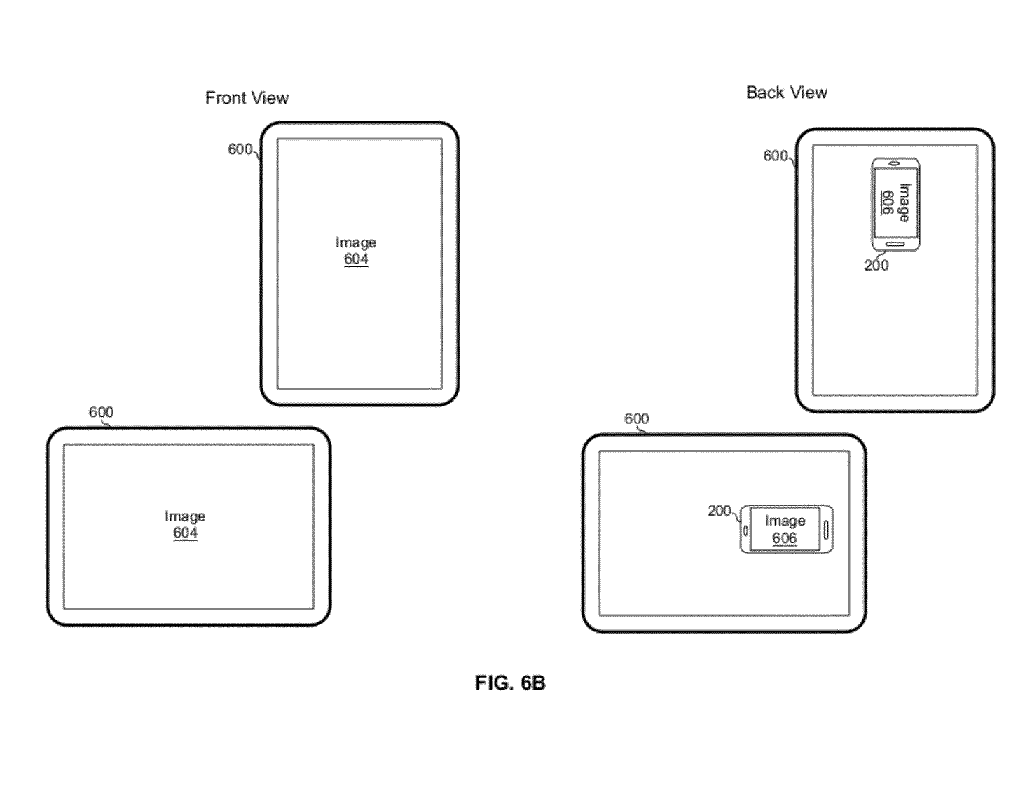

FIGS. 6A and 6B illustrate an example of a mobile device docking station (MDDS) having a form factor of a tablet device, in accordance with an embodiment of the invention. Nearly all of the front of the MDDS 600 may comprise a screen 102, which may be a touch screen. A receptacle 104 for mounting a mobile device 200 to the MDDS 600 may be located on the back of the MDDS 600. Although the receptacle 104 is shown located at the top center of the back of the MDDS 600, the invention need not be so limited. For example, the receptacle 104 may be positioned in a location where the fingers of a user of the MDDS 600 may comfortably rest while holding the MDDS 600. In this manner, the user may be enabled to interact with buttons and/or a touch screen of the mobile device 200 while holding the MDDS 600 and looking at the screen 102. FIG. 6A depicts the mobile device 200 undocked and FIG. 6B depicts the mobile device 200 docked to the MDDS 600. While the device 200 is docked to the MDDS 600, a user may provide input to the device 200 and/or the MDDS 600 via the touch screen 202 of the device 200 and/or the touch screen 102 of the MDDS 600.

In FIG. 6B, the MDDS 600 may display an image 604 and the docked mobile device 200 may display an image 606. In an embodiment of the invention, the screen 202 of the mobile device 200 and/or the screen 102 of the MDDS 600 may be disabled at various times to conserve battery power. Disabling the screen 202 and/or the screen 102 may be done based on, for example, user selection and/or an automatic determination that the user is not looking at that screen (e.g., based on input from an accelerometer and/or optical sensor such as the camera 110a and/or the camera 220). A multitude of view/display options for the images 604 and 606 are discussed below with respect to FIGS. 10A-10D.

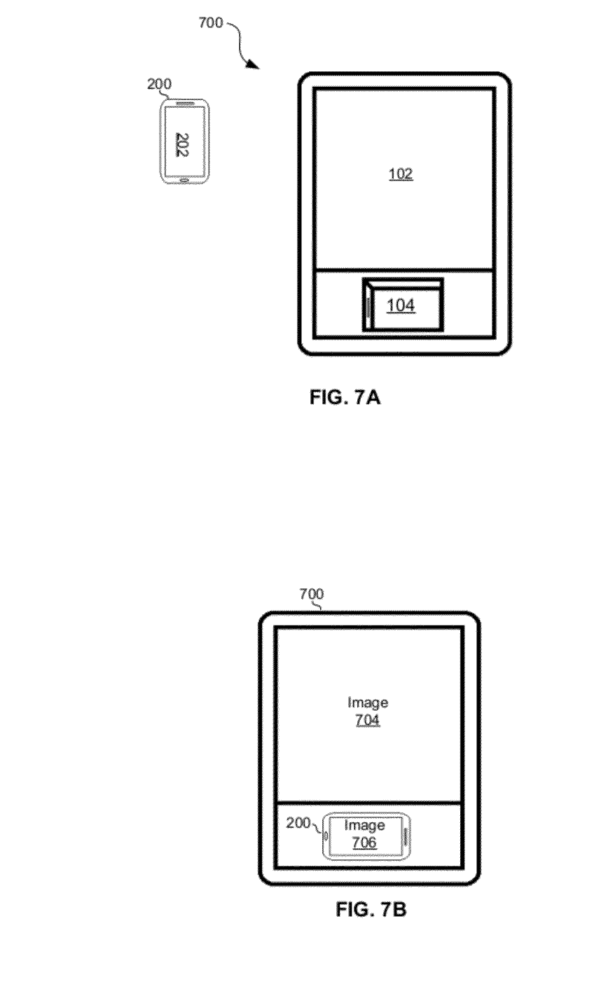

FIGS. 7A and 7B illustrate another example of a mobile device docking station (MDDS) having a form factor of a tablet device, in accordance with an embodiment of the invention. The receptacle 104 may be located on the front of the MDDS 700 below the screen 102. FIG. 7A depicts the mobile device 200 undocked and FIG. 7B depicts the mobile device 200 docked to the MDDS 700. While the device 200 is docked to the MDDS 700, a user may provide input to the device 200 and/or the MDDS 700 via the touch screen 202 of the device 200 and/or the touch screen 102 of the MDDS 700. In an embodiment of the invention, the docked mobile device 200 may be utilized as the primary, or perhaps sole, input device of the MDDS 700 in instances that the screen 102 is not a touch screen.

In FIG. 7B, the MDDS 700 may display an image 704 and the docked mobile device 200 may display an image 706. There may be a variety of display/view options for these two images as discussed below with respect to FIGS. 10A-10D.

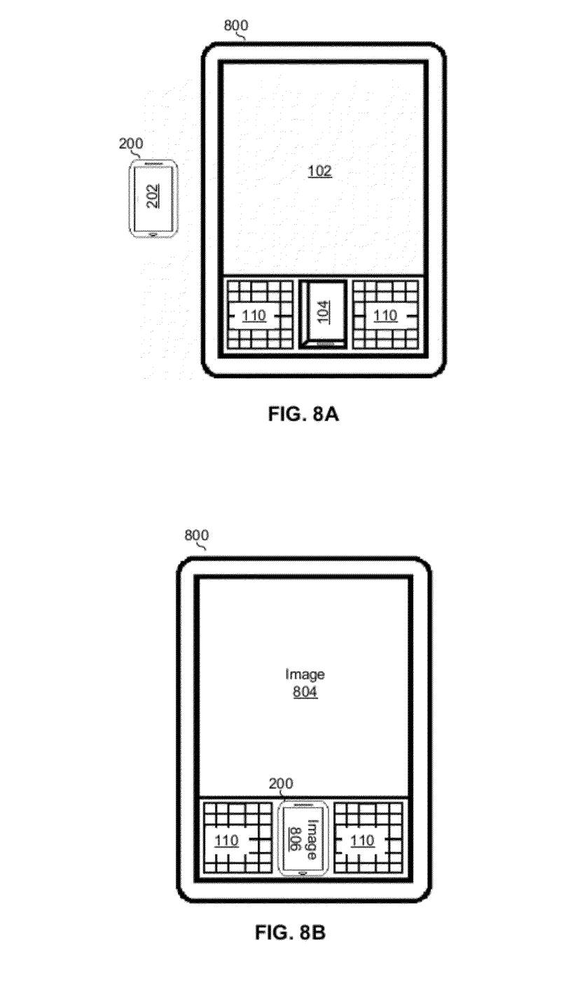

FIGS. 8A and 8B illustrate another example of a mobile device docking station (MDDS) having a form factor of a tablet device, in accordance with an embodiment of the invention. The MDDS 800 is similar to the MDDS 700 but additionally comprises input device(s) 110 in the area below the screen 102. While the device 200 is docked to the MDDS 800, a user may provide input to the device 200 and/or the MDDS 800 via the touch screen 202 of the device 200, via the controls 110 of the MDDS 800, and/or via the touch screen 102 of the MDDS 800.

In FIG. 8B, the MDDS 800 may display an image 804 and the docked mobile device 200 may display an image 806. There may be a variety of display/view options for these two images as discussed below with respect to FIGS. 10A-10D.

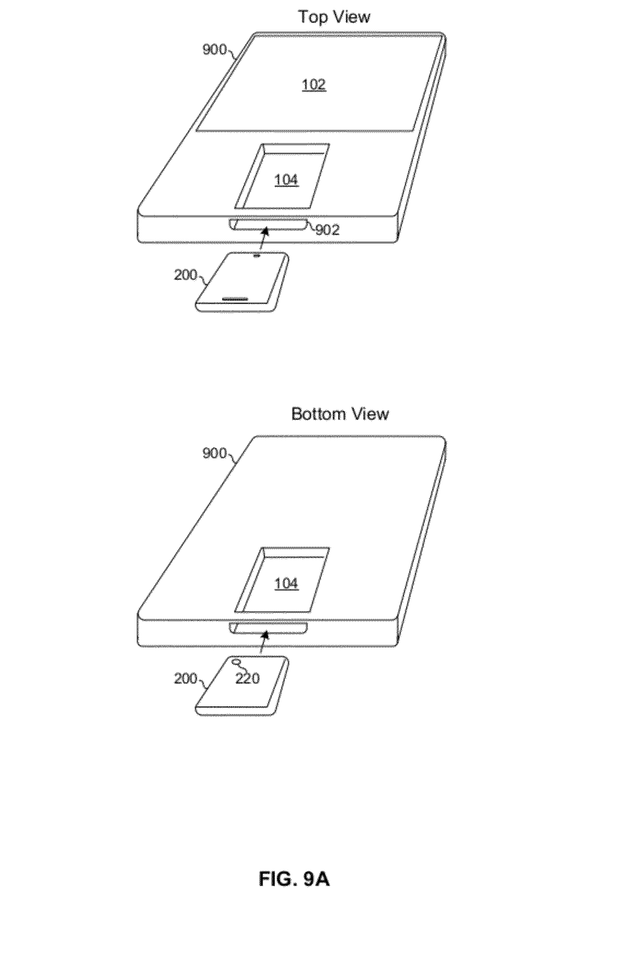

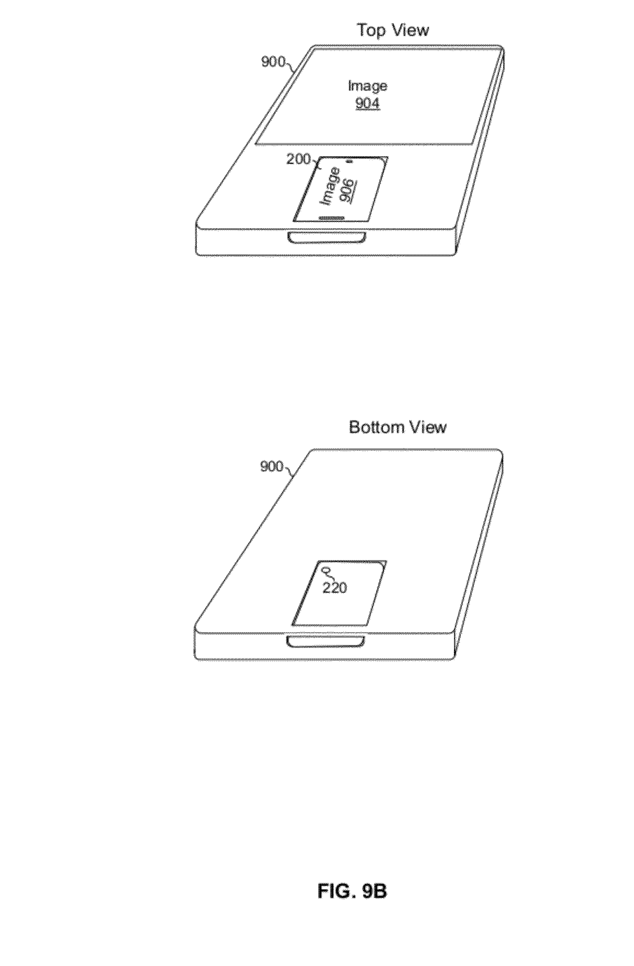

FIGS. 9A and 9B illustrate an example of a mobile device docking station (MDDS) for which a mobile device is docked with the MDDS 900 by sliding the mobile device in via an opening in the edge of the MDDS 900, in accordance with an embodiment of the invention. Referring to FIG. 9A, the mobile device 200 may slide into the receptacle 104 through the opening 902 in the edge of the MDDS 900. In an embodiment of the invention, a door or latch may close over at least a portion of the opening 902 to hold the docked mobile device 200 in place. FIG. 9A shows the mobile device 200 undocked and FIG. 9B shows the mobile device 200 docked to the MDDS 900. While the device 200 is docked to the MDDS 900, a user may provide input to the device 200 via the controls 110 of the MDDS 900 and/or via the touch screen 102 of the MDDS 900.

In an embodiment of the invention, the opening 902 may enable a user to access ports or controls on corresponding edge of a mobile device 200 while the mobile device 200 is docked.

In an embodiment of the invention, as shown in the bottom view of FIG. 9A, the receptacle 104 may be such that the back of a docked mobile device 200 is also accessible to a user. In this manner, a camera 220 on the back of the mobile device 200 may be used while the device 200 is docked in the MDDS 900.

In FIG. 9B, the MDDS 900 may display an image 904 and the docked mobile device 200 may display an image 906. There may be a variety of display/view options for these two images as discussed below with respect to FIGS. 10A-10D.

FIGS. 10A-10D illustrate multiple display/view for a mobile device docked with a mobile device docking station (MDDS), in accordance with an embodiment of the invention.

Referring to FIG. 10A, the image displayed on the screen 202 of the docked mobile device 200 may be substantially the same as the image displayed on the screen 102 of the MDDS 700. The images may differ in that scaling, compression, and/or other processing of a video signal may be necessary to make a particular video image suitable for the respective screens. In an embodiment of the invention, the screen 102 may be a touch screen and manipulations of the image on the screen 102 made using the touch screen 102 (e.g. zooming in, zooming out, panning, scrolling, etc.) may also be reflected on the screen 202. In another embodiment of the invention, a user may be able to manipulate the image on the screens 102 and 202 independently. For example, a user may zoom in on one portion of the image on the screen 202 while the screen 102 remains zoomed-out. As another example, a user may scroll to the bottom of an image on the screen 202 while the screen 102 remains at the top of the image. In this regard, the touch screen 102 may not be limited to just displaying video or image output from a mobile device but may be functionally equivalent to the touch screen 202 of the mobile device. That is, the screen 102 may be enabled to display anything which may be displayed on the screen 202 and a user may interact with the mobile device 200 and the MMDS 700 via the screen 102 just as he would interact with the mobile device 200 and the MMDS 700 via the screen 202.

Referring to FIG. 10B, the image displayed on the screen 202 of the docked mobile device 200 may be different than the image displayed on the screen 102 of the MDDS 700. For example, a window of a first application may be displayed on the screen 102 and a window of a second application may be displayed on the screen 202. As another example, different views or windows of the same application may be concurrently displayed on the screen 102 and the screen 202. For example, when running a web browser, a navigation bar—a plurality of links typically displayed along the top or side of a web page—may be displayed on the screen 202 while the screen 102 displays the rest of the web page. In this regard, the mobile device 200 and/or the MDDS 700 may be operable to parse the CSS and/or HTML of a web page and allocate various portions of the web page among the two screens based on the CSS and/or HTML. Similarly, when running other applications, tool bars may be displayed on the screen 202 while the main application window is displayed on the screen 102.

Referring to FIG. 10C, the screen 202 of the docked mobile device 200 may display various controls for interacting with the image displayed on the screen 102. For example, the mobile device 200 may display a monochrome field (e.g., a gray or black screen) and may function as a basic, or multi-touch, touchpad. As another example, the device 200 may display particular controls on screen 202 specifically suited for interacting with whatever is being displayed on the screen 102. For example, scroll bars, directional arrows, and/or controls specifically designed for use with various applications (e.g., games) may be displayed on the screen 202 of the mobile device 200. In an embodiment of the invention, while the screen 202 is displaying specialized controls for an application, a user may be enabled to interact with the operating system and/or provide other general-purpose input via the touch screen of the screen 102.

Referring to FIG. 10D, the screen 202 of the docked mobile device 200 may display a home screen (or a particular menu such as a task tray or start menu) while the screen 102 displays whatever applications or other images are in use. This may enable quickly opening new applications, toggling between open applications displayed on the screen 102, etc.

Various aspects of a method and system for a mobile device docking station are provided. In an exemplary embodiment of the invention, a docking device (e.g., device 700) may comprise a screen 102, controls (e.g., a touch screen 102 and/or controls 110), and a receptacle 104 for holding a mobile device. Information (e.g., image 704 or portions thereof) generated by a mobile device 200 may be displayed on the screen 102 while information (e.g., image 706 or portions thereof) generated by the first mobile device 200 may be displayed on a screen 202 of the mobile device 200. A user may be enabled to interact via the controls (e.g., touch screen 102 and/or controls 110) of the docking device 700 and the controls (e.g., touch screen 202 and/or controls 218) of the mobile device 200 with either or both of (1) the information displayed on the mobile device 200 and (2) the information displayed on the docking device 700. The information displayed on the docking device 700 may comprise a window of a first application running on the mobile device 200. The information displayed on the mobile device 200 may be a window of a second application running on the mobile device 200. The information displayed on the mobile device 200 may be a home screen of the mobile device 200. The information displayed on the mobile device 200 may comprise one or more controls that are specific to the first application. While applications are referred to as “running on” the mobile device, portions of that application may nonetheless be executed on, or otherwise supported by, the docking device 700

While the mobile device 200 is connected to the docking device 700, the docking device 700 may be operable to perform processing operations that are performed by the mobile device 200 when the mobile device 200 is not connected to the docking device 700. The processing operations may comprise audio processing operations and/or video processing operations. A processor 152 of the docking device may functions as a coprocessor performing processing operations allocated to it by the mobile device. The docking device 700 may comprise an antenna 164, may be operable to process wireless signals received via the antenna 164, and may be operable to convey the processed wireless signals to the mobile device 200. The docking device may be operable to process signals received from the mobile device 200, and transmit the processed signals via the antenna 164. In this manner, the mobile device 200 may be operable to transmit and receive wireless signals via the docking device 700 rather than via an antenna 272 of the mobile device 200. The docking device 700 may comprise a microphone 110b and a keyboard 110 and may be operable to convey input data from the microphone 110b and the keyboard 110 to the mobile device 200.

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the steps as described herein for a mobile device docking station.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiments disclosed, but that the present invention will include all embodiments falling within the scope of the appended claims.

What is claimed is:

1. A system comprising:
a docking device comprising a screen, controls, and a receptacle for holding a mobile device, wherein said docking device enables:
displaying information output by a mobile device on said screen while displaying information output by said mobile device on a screen of said mobile device;
interacting, via said controls of said docking device and controls of said mobile device, with at least one of: (1) an image displayed on said screen of said docking device, and (2) an image displayed on said screen of said mobile device.

2. The system according to claim 1 wherein, while said mobile device is connected to said docking device, said docking device is operable to perform processing operations that are performed by said mobile device when said mobile device is not connected to said docking device.

3. The system according to claim 2, wherein said processing operations comprise audio processing operations and/or video processing operations.

4. The system according to claim 1 wherein a processor of said docking device functions as a coprocessor performing processing operations allocated to it by said mobile device.

5. The system according to claim 1, wherein said docking device comprises an antenna, and said docking device is operable to:
process wireless signals received via said antenna; and
convey said processed wireless signals to said mobile device.

6. The system according to claim 1, wherein the docking device comprises an antenna, and the docking device is operable to:
process signals received from said mobile device; and
transmit said processed signals via said antenna.

7. The system according to claim 1, wherein said docking device:
comprises a microphone and at least one speaker;
is operable to convey input data from said microphone to said mobile device; and
is operable to convey output data from said mobile device to said at least one speaker.

8. The system according to claim 1, wherein said information displayed on said screen of said docking device comprises a window of a first application running on said mobile device and said information displayed on said screen of said mobile device comprises a window of a second application running on said mobile device.

9. The system according to claim 1, wherein said information displayed on said screen of said docking device comprises a window of an application running on said mobile device and said information displayed on said screen of said mobile device comprises a home screen of said mobile device.

10. The system according to claim 1, wherein said information displayed on said screen of said docking device comprises a window of an application running on said mobile device and said information displayed on said screen of said mobile device comprises one or more controls that are specific to said application.

11. A non-transitory storage having stored thereon a computer program having at least one code section executable by a mobile device for enabling the mobile device to:
generate and display information on a screen of said mobile device while concurrently generating and outputting information to a docking device for display on a screen of said docking device; and
manipulate, based on input from controls of said mobile device and on input from controls of said docking device, at least one of: (1) said information generated and displayed on said screen of said mobile device, and (2) said information generated and output for display on said screen of said docking device.

12. The non-transitory storage according to claim 11, wherein said at least one code section is executable by said mobile device for causing said mobile device to:
perform a particular one or more processing operations when not connected to said docking device; and
offload said particular one or more processing operations to said docking device while connected to said docking device.

13. The non-transitory storage according to claim 12, wherein said processing operations comprise audio processing operations and/or video processing operation.

14. The non-transitory storage according to claim 11, wherein said at least one code section is executable by said mobile device for causing said mobile device to allocate processing operations to a processor of said docking device.

15. The non-transitory storage according to claim 11, wherein said at least one code section is executable by said mobile device for causing said mobile device to transmit and receive wireless signals via said docking device rather than via an antenna of said mobile device.

16. The non-transitory storage according to claim 11, wherein said at least one code section is executable by said mobile device for causing said mobile device to receive input data from a microphone of said docking device and output data to at least one speaker of said docking device.

17. The non-transitory storage according to claim 11, wherein said information generated and displayed on said screen of said docking device comprises a window of a first application running on said mobile device and said information generated and displayed on said screen of said mobile device comprises a window of a second application running on said mobile device.

18. The non-transitory storage according to claim 11 wherein said information generated and displayed on said screen of said docking device comprises a window of an application running on said mobile device and said information generated and displayed on said screen of said mobile device comprises a home screen of said mobile device.

19. The non-transitory storage according to claim 11 wherein said information generated and displayed on said screen of said docking device comprises a window of an application running on said mobile device and said information generated and displayed on said screen of said mobile device comprises one or more controls that are specific to said application.

20. The non-transitory storage according to claim 11, wherein said at least at least one code section is executable by said mobile device for causing said mobile device to:
run a first operating system while said mobile device is connected to said docking device; and
run a second operating system while said mobile device is not connected to said docking device.
